(19) United States
(12) Patent Application Publication
(10) Pub. No.: US 2014/0008051 A1
(43) Pub. Date: Jan. 9, 2014

(54) Cooling System Integration

(71) Applicants: Timothy M. O'Donnell, Germantown Hills, IL (US); Evan E. Jacobson, Edwards, IL (US)

(72) Inventors: Timothy M. O'Donnell, Germantown Hills, IL (US); Evan E. Jacobson, Edwards, IL (US)

(73) Assignee: CATERPILLAR INC., Peoria, IL (US)

(21) Appl. No.: 13/543,435

(22) Filed: Jul. 6, 2012

(51) Int. Cl. G05D 23/19; F01P 7/16

(52) U.S. Cl. 165/297; 165/288; 165/294; 165/299

(57) ABSTRACT

A machine including an engine cooling system, a secondary system with a low-temperature limit, and a secondary cooling system. A temperature sensor is associated with the secondary cooling system. The temperature sensor senses the secondary cooling system temperature and provides a temperature signal. A control valve has an open position allowing fluid communication between the engine cooling system and the secondary cooling system, and a closed position disallowing fluid communication. A controller receives signals from the secondary system temperature sensor and commands the control valve to open when the secondary cooling system temperature is below the low-temperature limit.

### TECHNICAL FIELD

This patent disclosure relates generally to machine cooling systems and, more particularly, to secondary machine cooling systems.

### BACKGROUND

Machines that include secondary systems use components that have different cooling requirements than traditional machines without secondary systems. The individual components of secondary systems can operate in a temperature range that is much smaller than the temperature range for other types of systems. Some secondary system components have lower high-temperature limits and/or higher low-temperature limits than other machine systems. As a result, machines with secondary systems sometimes benefit from cooling systems to regulate the temperature of the machine components within the operational temperature range of the components.

Prior machines with secondary systems have used a separate cooling circuit for the secondary system components and the engine. Separate cooling systems for the engine and secondary system can result in increased costs and can use large amounts of space within a machine. Additionally, in some environmental conditions, such as in cold climates, the cooling circuit for the secondary system may not have the ability on its own to warm the secondary systems to their low-temperature limit.

### SUMMARY

The disclosure describes, in one aspect, a machine including an engine cooling system, a secondary system with a low-temperature limit, and a secondary cooling system operatively associated with the secondary system. The machine also includes at least one secondary system temperature sensor operatively associated with the secondary cooling system. The secondary system temperature sensor is adapted to sense a temperature of the secondary cooling system and to provide a signal indicative of the temperature of the secondary cooling system. The machine includes a control valve. The control valve has an open position that allows fluid communication between the engine cooling system and the secondary cooling system, and a closed position that disallows fluid communication between the engine cooling system and the secondary cooling system. The machine also includes a controller operatively associated with the control valve. The controller is adapted to receive signals from the secondary system temperature sensor indicative of the temperature of the secondary cooling system and command the control valve to move to the open position when the temperature of the secondary cooling system is below the low-temperature limit.

In another aspect, the disclosure describes a machine including an engine, an engine cooling system operatively associated with the engine, and an engine system temperature sensor adapted to sense a temperature of the engine cooling system. The engine system temperature sensor is also adapted to provide a signal indicative of the temperature of the engine cooling system. The machine also includes a secondary system with a low-temperature limit, a secondary cooling system operatively associated with the secondary system, and at least one secondary system temperature sensor adapted to sense a temperature of the secondary cooling system. The secondary temperature sensor is also adapted to provide a signal indicative of the temperature of the secondary cooling system. The machine includes a control valve having an open position that allows fluid communication between the engine cooling system and the secondary cooling system, and a closed position that disallows fluid communication between the engine cooling system and the secondary cooling system. The machine also has a controller operatively associated with the control valve. The controller is adapted to receive signals from the secondary system temperature sensor indicative of the temperature of the secondary cooling system, and to receive signals from the engine system temperature sensor indicative of the temperature of the engine cooling system. The controller is also adapted to command the control valve to move to the open position when the temperature of the secondary cooling system is below the low-temperature limit and the temperature of the engine cooling system is above the low-temperature limit.

In yet another aspect, the disclosure describes a method of integrating a cooling system. The method includes sensing a temperature of a secondary cooling system and comparing the temperature of the secondary cooling system to a low-temperature limit of a secondary system. The method also includes moving a control valve from a closed position that does not allow fluid communication between the secondary cooling system and an engine cooling system to an open position that allows fluid communication between the secondary cooling system and the engine cooling system if the temperature of the secondary cooling system is lower than the low-temperature limit.

### BRIEF DESCRIPTION OF THE DRAWING

FIG. 1 is a schematic illustration of a machine in accordance with the disclosure.

FIG. 2 is a another schematic illustration of the machine of FIG. 1.

FIG. 3 is a schematic illustration of another embodiment of a machine in accordance with the disclosure.

FIG. 4 is a flow chart illustrating a method of integrating a cooling system in accordance with the disclosure.

FIG. 5 is a flow chart illustrating another method of integrating a cooling system in accordance with the disclosure.

FIG. 6 is a flow chart illustrating another method of integrating a cooling system in accordance with the disclosure.

FIG. 7 is a flow chart illustrating another method of integrating a cooling system in accordance with the disclosure.

### DETAILED DESCRIPTION

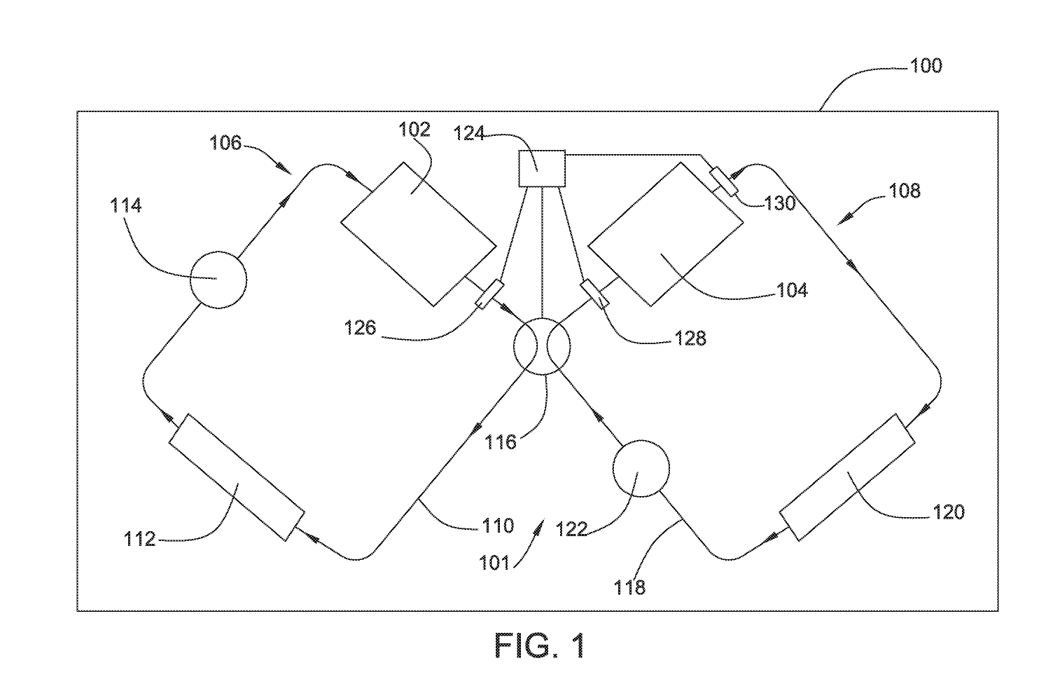

This disclosure relates to an apparatus and methods for integrating a secondary cooling system with an engine cooling system to ensure that the temperature of a secondary system remains within the operational temperature range of the system during operation. FIG. 1 illustrates a machine 100 with an integrated cooling system 101. The machine 100 includes an engine 102, a secondary system 104, an engine cooling system 106, and a secondary cooling system 108. The engine cooling system 106 is operatively associated with the engine 102, that is, the engine cooling system 106 provides coolant to the engine 102 to regulate engine temperature. The illustrated engine cooling system 106 includes an engine system pump 114 that pumps coolant through at least one engine system coolant line 110, through the engine 102, and through an engine system radiator 112. The engine cooling system 106 can have more or fewer components depending on system design.

The engine cooling system 106 further includes a control valve 116. In the embodiment illustrated in FIG. 1, the control valve 116 is in a closed position. The engine system pump 114 pumps coolant through the engine 102, where heat from the engine 102 is transferred to the coolant. When the control valve 116 is in the closed position, the coolant then passes through the control valve 116, then passes through the engine system radiator 112, where some heat from the coolant dissipates. The coolant then continues through the engine system pump 114 to be pumped into the engine 102 and complete the cycle. This cooling cycle continues at least while the engine 102 is operating and the control valve 116 is in the closed position.

The secondary system 104 is operatively associated with the secondary cooling system 108, which provides coolant to regulate the secondary system component temperature. The secondary system 104 can be any of a variety of systems including hybrid electric systems, other hybrid systems, transmission systems, hydraulic pumps, etc. Similar to the engine cooling system 106, the secondary cooling system 108 has secondary system coolant lines 118 that carry coolant to and/or through the secondary system 104, and to and/or through other components of the secondary cooling system, such as the secondary system radiator 120, and the secondary system pump 122. The secondary cooling system 108 can have more or fewer components, depending on system design.

In accordance with the disclosure, the machine 100 further includes a control valve 116 disposed between the engine cooling system 106, and the secondary cooling system 108. As illustrated in the embodiment of FIG. 1, when the control valve 116 is in a closed position, each of the engine cooling system 106 and the secondary cooling system 108 operate separately, the respective pumps 114, 122 circulating coolant through the respective lines 110, 118, to/through the components associated with the respective systems 106, 108.

That is, the engine system pump 114 pumps coolant through the engine 102, where heat from the engine 102 is transferred to the coolant. The coolant then passes through the control valve 116, then passes through the engine system radiator 112, where some heat from the coolant dissipates. The coolant then continues through the engine system pump 114 to be pumped into the engine 102 and complete the cycle. This cooling cycle continues at least while the engine 102 is operating and the control valve 116 is in the closed position.

Similarly, when the control valve 116 is in the closed position, the secondary system pump 122 pumps coolant through control valve 116 and to/through the secondary system 104. If the temperature of the secondary system 104 is higher than the coolant temperature, heat is transferred from the secondary system 104 into the coolant. If the temperature of the coolant is higher than the temperature of the secondary system 104, heat is transferred from the coolant to the secondary system 104. The coolant then passes through the secondary system radiator 120, where heat can dissipate from the coolant.

The direction of coolant flow in both the secondary cooling system 108 and the engine cooling system 106 is indicated by arrows in the figures, but other suitable flow directions and component designs are contemplated. Additionally, the positions of components illustrated in FIG. 1 for both the engine cooling system 106 and the secondary cooling system 108 represent just one example of possible component positioning; however, other component positioning in each system is contemplated herein.

The control valve 116 may alternately be utilized to establish fluid communication between the engine cooling system 106 and the secondary cooling system 108, depending upon identified temperature characteristics. The operative position of the control valve 116 may be established based upon, for example, environmental conditions, standardized timeframes, specified operating temperature ranges of components within the secondary cooling system 108, the temperature of components within the secondary system 104, and/or temperatures of the respective coolants flowing within the engine cooling system 106 and the secondary cooling system 108. Any appropriate arrangement may be provided for measurement of temperatures.

As shown in the embodiment in FIG. 1, an engine system temperature sensor 126 is operatively associated with the engine cooling system 106 such that the engine system temperature sensor 126 can sense the temperature of the coolant running through the engine cooling system 106. In other embodiments, the engine cooling system 106 can have any number of temperature sensors, including no temperature sensors whatsoever.

The illustrated embodiment further includes a first secondary system temperature sensor 128 and a second secondary system temperature sensor 130, both operatively associated with the secondary cooling system 108. The first secondary system temperature sensor 128 is adapted to sense coolant temperature at a point before the coolant enters the secondary system 104, while the second secondary system temperature sensor 130 is adapted to sense the coolant temperature after the coolant exits the secondary system. Though FIG. 1 shows the first and second secondary system temperature sensors 128, 130 operatively connected to the secondary system coolant lines 118 before and after the secondary system 104, any number of sensors can be used and can be in different locations in the secondary cooling system 108. In some embodiments, only one secondary system temperature sensor is used.

In the embodiment in FIG. 1, engine system temperature sensor 126, the first secondary system temperature sensor 128, the second secondary system temperature sensor 130, and the control valve 116 are all operatively connected to a controller 124. The temperature sensors 126, 128, 130 are all adapted to send signals indicative of the coolant temperature at the sensor location to the controller 124. The controller 124 is adapted to receive the signals from the temperature sensors 126, 128, 130 and compare the sensor temperatures to one another and to predetermined high- and low-temperature limits of the secondary system.

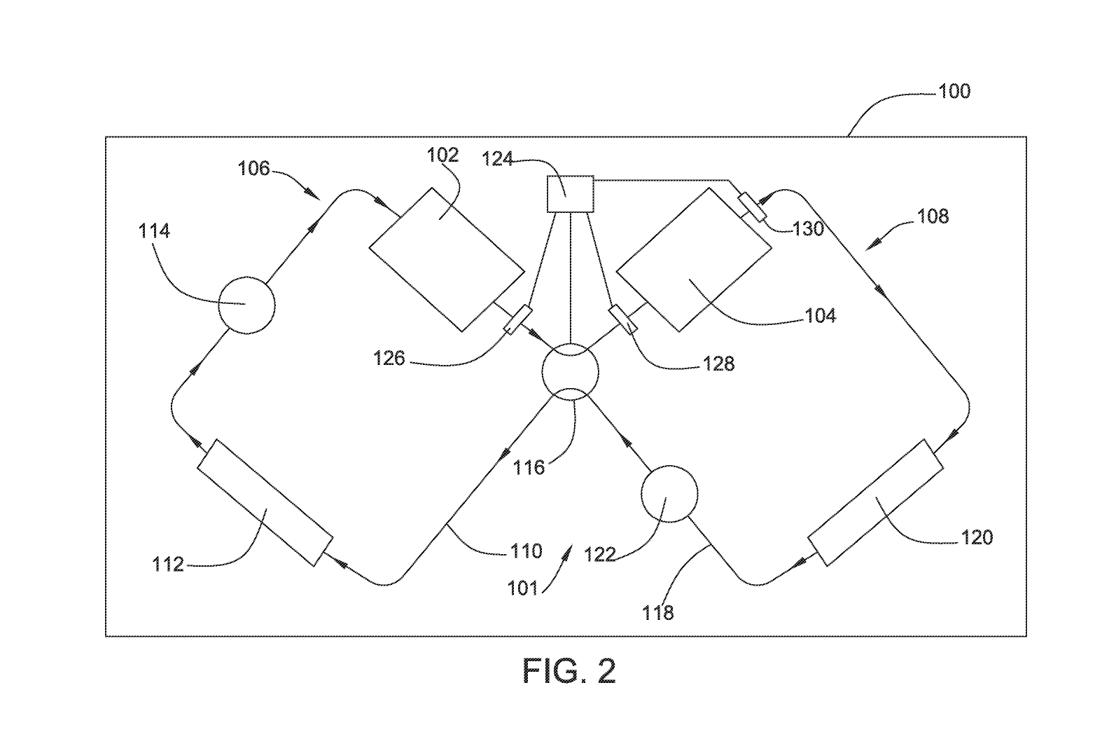

In one embodiment, if the controller 124 determines that the temperature of the secondary cooling system 108 from either the first or second secondary system temperature sensors 128, 130 is below the low-temperature limit of the secondary system, the controller commands the control valve 116 to move from the closed position into an open position. The embodiment of the control valve 116 shown in the figures is simply for illustrative purposes, and many variations of control valves are contemplated. When the control valve 116 is in the open position, as is illustrated in FIG. 2, the engine cooling system 106 and the secondary cooling system 108 are in fluid communication with one another, allowing coolant to pass between the engine cooling system to the secondary cooling system through the control valve. In the open configuration shown in FIG. 2, hot coolant from the engine cooling system 106 flows into the secondary system 104 and dissipates heat into the secondary system 104. As the heat dissipates, the temperature of the secondary system 104 increases. The coolant then continues through the secondary system radiator 120 and through the secondary system pump 122. The coolant then flows back through the control valve 116 and into the engine cooling system 106, where it passes through the engine system radiator 112, the engine system pump 114, and then back through the engine 102. The coolant absorbs heat from the engine 102 and continues around the entire circuit as long as the control valve 116 remains in an open position. As the temperature of the secondary system 104 increases, less heat dissipates from the coolant into the secondary system 104, which increases the coolant temperature in the secondary cooling system 108 at points after the coolant has passed through the secondary system 104. In such an embodiment, the controller 124 is adapted to command the control valve 116 to move from the open position to the closed position when the controller 124 that an increased secondary coolant temperature is no longer required. For example, the controller 124 may cause the control valve 116 to move to a closed position when it is determined that the temperature of the secondary cooling system 108 sensed by either the first or second secondary system temperature sensor 128, 130 exceeds a predetermined temperature above the low-temperature limit.

In another embodiment, the controller 124 is adapted to command the control valve 116 to move from the closed position to the open position when the controller 116 determines that the temperature of the secondary cooling system 108 as sensed by the first secondary system temperature sensor 128 is lower than a predetermined low-temperature limit. In such an embodiment, the controller 124 is also adapted to move the control valve 116 to the closed position when it determines that the temperature of the secondary cooling system 108 as sensed by the second secondary system temperature sensor 130 exceeds a predetermined temperature above the low-temperature limit.

In yet another embodiment, the controller 124 is adapted to command the control valve 116 to move from an closed position to an open position when the controller determines that the temperature in the secondary cooling system 108 as sensed by the first secondary system temperature sensor 128 is lower than the low-temperature limit of the secondary system 104 and the temperature of the engine cooling system 106 as sensed by the engine system temperature sensor 126 is higher than the low-temperature limit of the secondary system. In this embodiment, the controller 124 may leave the engine cooling system 106 separate from the secondary cooling system 108 if the coolant in the engine cooling system 106 would not cause an increase in the temperature of the secondary system 104 such that it would exceed the low-temperature limit. With the engine cooling system 106 separated from the secondary cooling system 108, the coolant in the engine system 106 can increase in temperature more quickly by absorbing heat from the operating engine 102 than when the coolant flows through both cooling systems 106, 108. When the coolant in the engine cooling system 106 reaches a temperature that exceeds the low-temperature limit of the secondary system 104, the controller 124 causes the control valve 116 to open. This allows the relatively hot coolant from the engine cooling system 106 to flow into the secondary system 104, increasing the temperature of the secondary system 104.

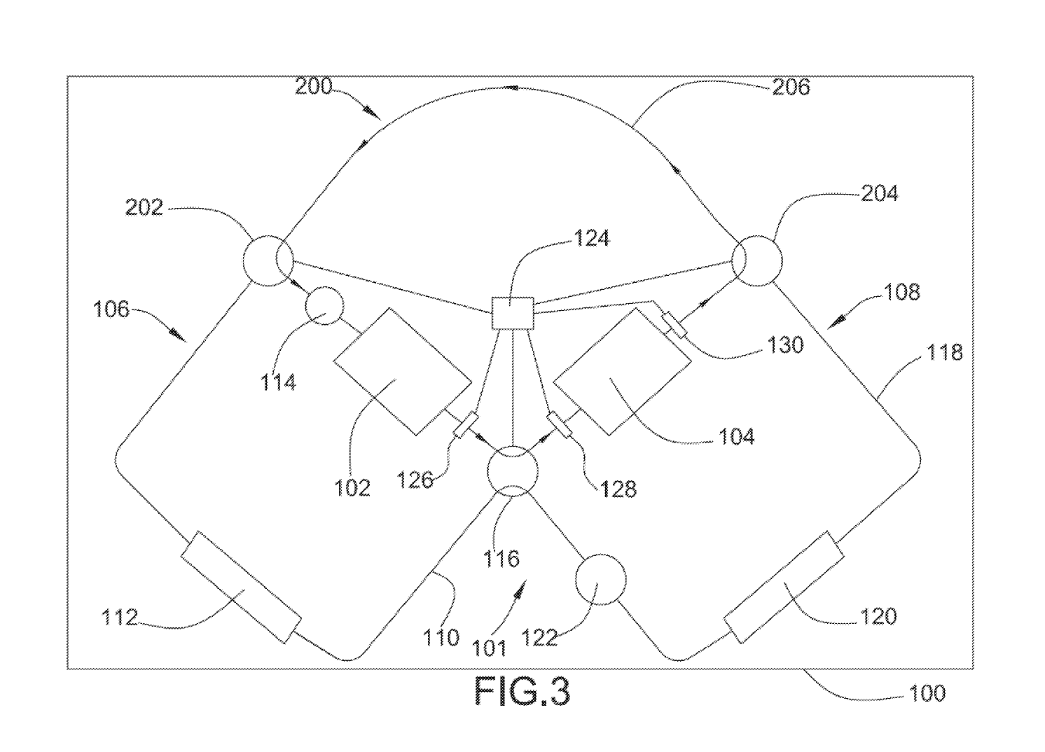

FIG. 3 illustrates another embodiment of the integrated cooling system 101 that includes a bypass system 200. The bypass system 200 includes a first bypass valve 202, a second bypass valve 204, and bypass coolant lines 206 that carry coolant through the bypass system. The first bypass valve 202 and the second bypass valve 204 are both operatively connected to the controller 124. The controller 124 is adapted to command the first bypass valve 202 to selectively move between an engine system position and a bypass system position. In the bypass system position, the first bypass valve 202 allows fluid communication between the engine cooling system 106 and the bypass system 200. In the engine system position, the first bypass valve 202 does not allow fluid communication between the engine cooling system 106 and the bypass system 200. The controller 124 is also adapted to command the second bypass valve 204 to selectively move between a bypass position and a secondary system position. In the bypass system position, the second bypass valve 204 allows fluid communication between the bypass system 200 and the secondary cooling system 108. In the secondary cooling system position, the second bypass valve 204 does not allow fluid communication between the bypass system 200 and the secondary cooling system 108.

In the embodiment illustrated in FIG. 3, the controller 124 can command the first bypass valve 202 and the second bypass valve 204 to move to their respective bypass system positions when the controller commands the control valve 116 to move from a closed position to an open position. In FIG. 3, the first and second bypass valves 202, 204 are shown in the bypass system position and the control valve 116 is shown in the open position. In such a configuration, fluid communication is established between the engine cooling system 106, the secondary cooling system 108, and the bypass system 200. The engine system pump 114 pumps coolant through the engine 102, through the control valve 116 into the secondary cooling system 108, through the secondary system 104, through the second bypass valve 204, through the bypass system 200, and back into the engine cooling system 106 through the first bypass valve 202.

It is contemplated that the secondary system pump 122 can be positioned on the secondary system coolant lines 118 between the control valve 116 and the second bypass valve 204, such that the secondary system pump can pump the coolant through the bypass system 200. Alternatively, it is contemplated that a bypass pump (not shown), or any other pump, could be positioned in the bypass system 200 to pump coolant through the bypass system, the engine cooling system 106, and the secondary cooling system 108. In embodiments such as that illustrated in FIG. 3, the coolant can bypass several components in the secondary cooling system 108 and the engine cooling system 106 after transferring heat to the secondary system 104. Depending on the particular system design, the coolant can bypass the secondary system radiator 120, the secondary system pump 122, the engine system radiator 112, and the engine system pump 114. Bypassing these components can increase the speed in which coolant from the engine 102 raises the temperature of the secondary system 104 because the coolant has less distance to travel to re-enter the engine 102 and absorb engine heat for transfer to the secondary system 104.

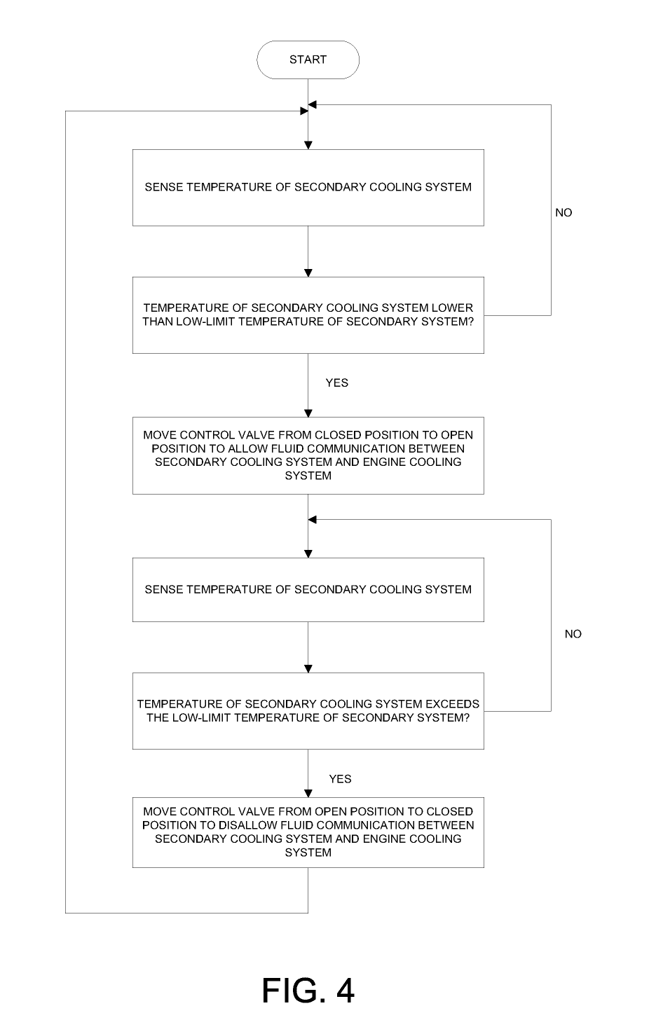

FIG. 4 illustrates one method of implementing the integrated cooling system 101 disclosed herein. In the illustrated method, the first secondary system temperature sensor 128 located upstream from the secondary system 104 senses the temperature of the secondary cooling system 108 and sends a signal to the controller 124 indicative of that temperature. The controller 124 compares the sensed temperature of the secondary cooling system 108 to the low-temperature limit of the secondary system 104. If the temperature of the secondary cooling system 108 is above the temperature of the low-temperature limit of the secondary system 104, the controller 124 makes no adjustment to the control valve 116 and the first secondary system temperature sensor 128 continues to send signals to the controller indicative of the secondary cooling system 108 temperature.

If the sensed temperature of the secondary cooling system 108 is below the low-temperature limit of the secondary system 104, the controller 124 commands the control valve 116 to move from the closed position to the open position to allow fluid communication between the engine cooling system 106 and the secondary cooling system 108. While the control valve 116 is in the open position, the second secondary system temperature sensor 130 located downstream from the secondary system 104 senses the temperature of the secondary cooling system 108 and sends a signal to the controller 124 indicative of the sensed temperature. The controller 124 compares the sensed temperature of the secondary cooling system 108 to the low-temperature limit of the secondary system 104. If the sensed temperature of the secondary cooling system 108 is below the low-temperature limit of the secondary system 104, the controller 124 does nothing and the control valve 116 remains in the open position. If the controller 124 determines that the sensed temperature of the secondary cooling system 108 exceeds the low-temperature limit of the secondary system 104, then the controller 124 commands the control valve 116 to move from the open position to the closed position, disallowing fluid communication between the engine cooling system 106 and the secondary cooling system 108. In some embodiments, the controller 124 will move the control valve 116 from the open position to the closed position only if the sensed temperature of the secondary cooling system 108 exceeds a predetermined temperature above the low-temperature limit of the secondary system 104.

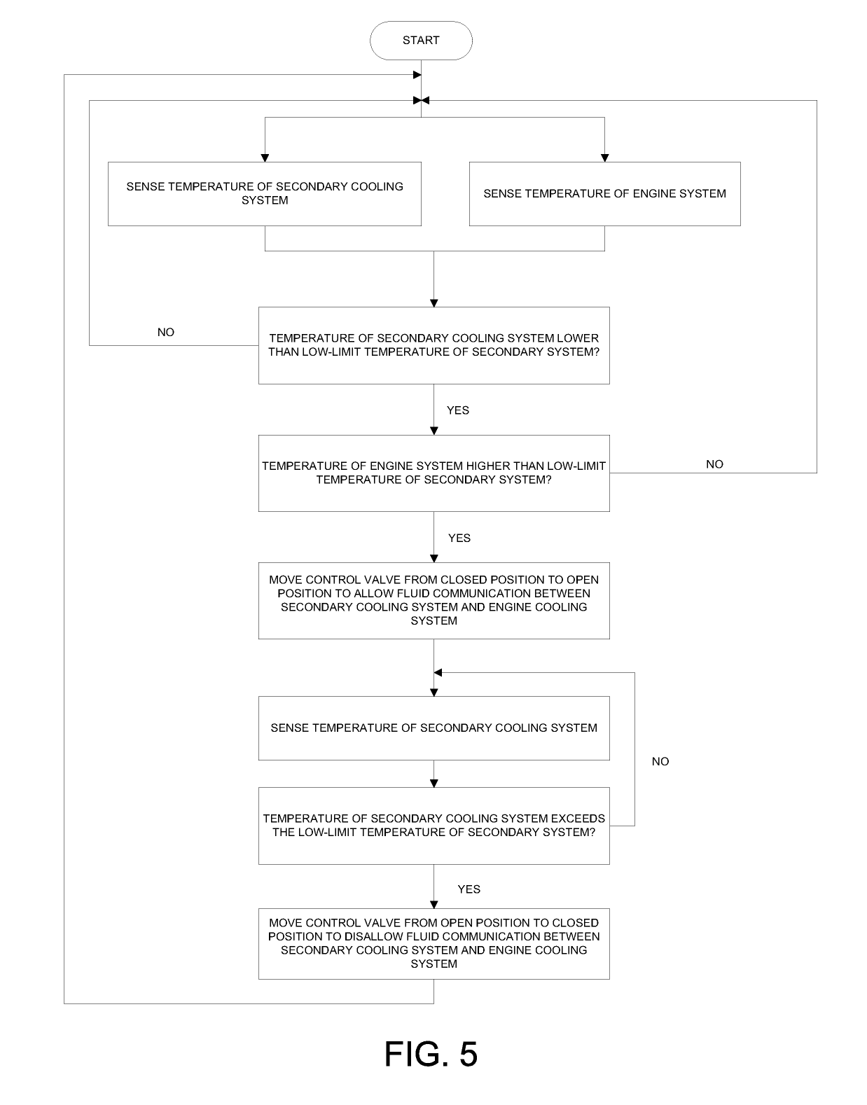

FIG. 5 illustrates another method of implementing the integrated cooling system 101 disclosed herein. In the illustrated embodiment, the temperature of the engine cooling system 106 is sensed by the engine system temperature sensor 126, and the first secondary system temperature sensor 128 senses the temperature of the secondary cooling system 108. Each temperature sensor 126, 128 sends a signal to the controller 124 indicative of the temperature of the engine cooling system 106 and the secondary cooling system 108, respectively. The controller 124 compares the sensed temperature of the secondary cooling system 108 and the sensed temperature of the engine cooling system 106 to the low-temperature limit of the secondary system 104. If the temperature of the secondary cooling system 108 is higher than the low-temperature limit of the secondary system 104 or the sensed temperature of the engine cooling system 106 is lower than the low-temperature limit of the secondary system, the controller 124 does nothing and the control valve 116 remains in the closed position.

However, if the sensed temperature of the secondary cooling system 108 is lower than the low-temperature limit of the secondary system 104 and the sensed temperature of the engine cooling system 106 is higher than the low-temperature limit of the secondary system, the controller 124 commands the control valve 116 to move from the closed position to the open position. With the control valve 116 in the open position, the engine cooling system 106 fluidly communicates with the secondary cooling system 108. When the control valve 116 in the open position, the second secondary system temperature sensor 130 sends a signal to the controller 124 indicative of the temperature of the secondary cooling system 108. The controller 124 compares the sensed temperature of the secondary cooling system 108 to the low-temperature limit of the secondary system 104. If the controller 124 determines that the sensed temperature of the secondary cooling system 108 exceeds the low-temperature limit of the secondary system 104, the controller commands the control valve 116 to move from the open position to the closed position, disallowing fluid communication between the engine cooling system 106 and the secondary cooling system 108.

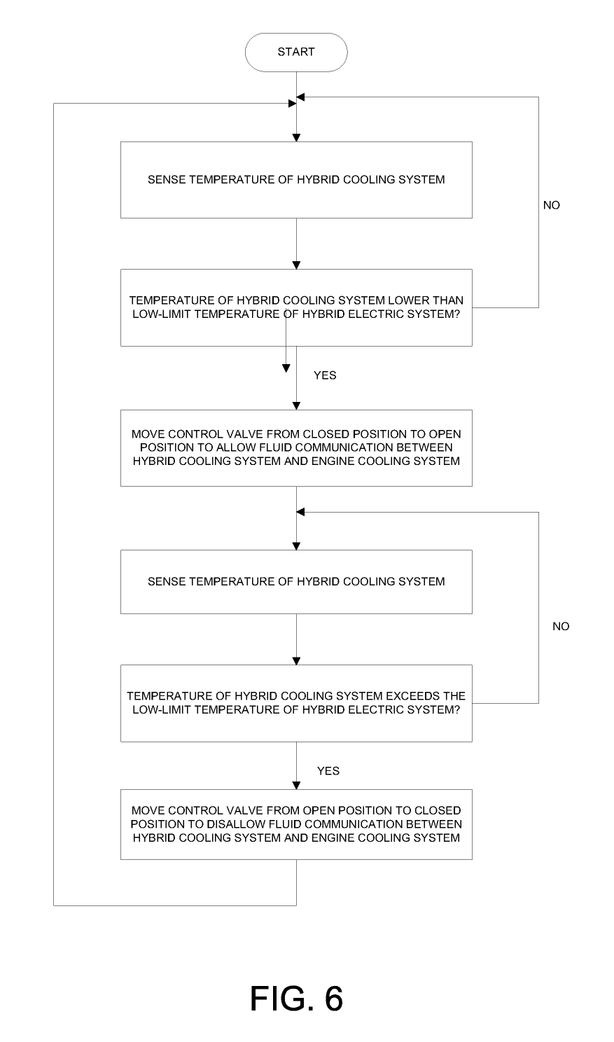

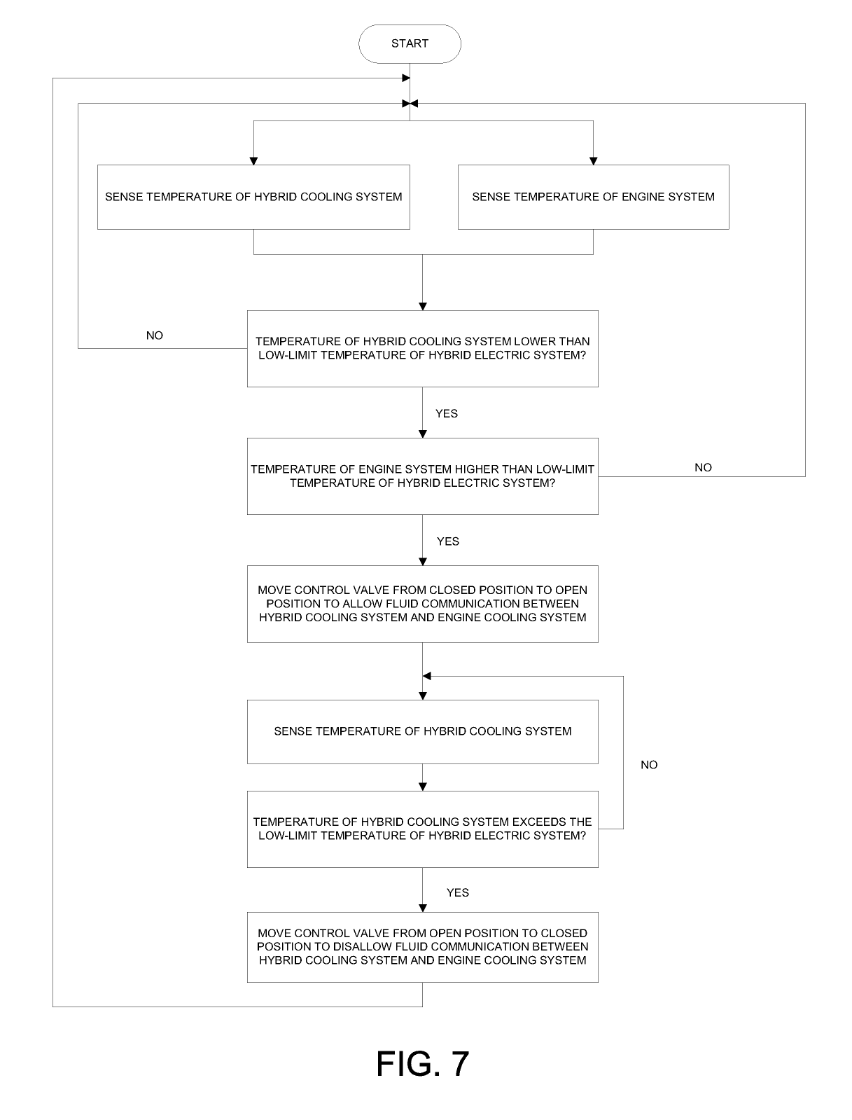

FIG. 6 and FIG. 7 illustrates embodiments of the integrated cooling system 101 in which the secondary system 104 is a hybrid electric system and the secondary cooling system 108 is a hybrid cooling system. In such embodiments, the low-temperature limit associated with the secondary system 104 is a low-temperature limit for the hybrid electric system.

In some embodiments, the controller 124 will move the control valve 116 from the open position to the closed position only if the sensed temperature of the secondary cooling system 108 exceeds a predetermined temperature above the low-temperature limit of the secondary system 104. Additionally, it is contemplated that in embodiments illustrated in FIG. 4 and FIG. 5, the first secondary system temperature sensor 128 can be located downstream of the secondary system 104 and the second secondary system temperature sensor 130 can be located upstream of the secondary system, or vice versa. In other embodiments, it is contemplated that the temperature of the secondary cooling system 108 is sensed by a single temperature sensor, or more than two temperature sensors, depending on the particular design implemented.

The controller 124 of this disclosure may be of any conventional design having hardware and software configured to perform the calculations and send and receive appropriate signals to perform the engagement logic. The controller 124 may include one or more controller units, and may be configured solely to perform the secondary cooling system integration, or to perform the secondary cooling system integration and other processes of the machine 100. The controller unit may be of any suitable construction, however in one example it comprises a digital processor system including a microprocessor circuit having data inputs and control outputs, operating in accordance with computer-readable instructions stored on a computer-readable medium. Typically, the processor will have associated therewith long-term (non-volatile) memory for storing the program instructions, as well as short-term (volatile) memory for storing operands and results during (or resulting from) processing.

In the arrangement illustrated herein has universal applicability in various types of machines. The term “machine” may refer to any machine that performs some type of operation associated with an industry such as mining, construction, farming, transportation, or any other industry known in the art. For example, the machine may be an earth-moving machine, such as a wheel loader, excavator, dump truck, backhoe, motor grader, material handler or the like. Moreover, an implement may be connected to the machine. Such implements may be utilized for a variety of tasks, including, for example, loading, compacting, lifting, brushing, and include, for example, buckets, compactors, forked lifting devices, brushes, grapples, cutters, shears, blades, breakers/hammers, augers, and others.

### INDUSTRIAL APPLICABILITY

The industrial application for the machine and methods for integrating a secondary cooling system with an engine cooling system as described herein should be readily appreciated from the foregoing discussion. The present disclosure may be applicable to any type of machine utilizing a secondary system and an engine with a cooling system. It may be particularly useful in machines with secondary systems that may operate in very low temperatures.

The disclosure, therefore, may be applicable to many different machines and environments. One exemplary machine suited to the disclosure is an off-highway truck. Off-highway trucks operate in a wide variety of temperature conditions, including low temperatures. Thus, a machine and methods for integrating a secondary cooling system with an engine cooling system would be useful in an off-highway truck.

Further, the methods above can be adapted to a large variety of machines. For example, other types of industrial machines, such as backhoe loaders, compactors, feller bunchers, forest machines, industrial loaders, wheel loaders and many other machines can benefit from the methods and systems described.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A machine comprising:
an engine cooling system;
a secondary system with a low-temperature limit;
a secondary cooling system operatively associated with the secondary system;
at least one secondary system temperature sensor operatively associated with the secondary cooling system, the at least one secondary system temperature sensor adapted to sense a temperature of the secondary cooling system, and to provide a signal indicative of the temperature of the secondary cooling system;
a control valve including an open position that allows fluid communication between the engine cooling system and the secondary cooling system, and a closed position that disallows fluid communication between the engine cooling system and the secondary cooling system; and
a controller operatively associated with the control valve, the controller adapted to receive signals from the at least one secondary system temperature sensor indicative of the temperature of the secondary cooling system and command the control valve to move to the open position when the temperature of the secondary cooling system is below the low-temperature limit.

2. The machine of claim 1, wherein the controller is further adapted to close the control valve when the temperature of the secondary cooling system exceeds a predetermined temperature above the low-temperature limit.

3. The machine of claim 1, further comprising:
an engine system temperature sensor operatively associated with the engine cooling system, the engine system temperature sensor adapted to sense the temperature of the engine cooling system, and to provide a signal indicative of the temperature of the engine cooling system;
wherein the controller is further adapted to:
receive signals from the engine system temperature sensor indicative of the temperature of the engine cooling system; and
command the control valve to move to the open position when the temperature of the secondary cooling system is below the low-temperature limit and the temperature of the engine cooling system is above the low-temperature limit.

4. The machine of claim 1, further comprising:
a bypass system in fluid communication with the engine cooling system and the secondary cooling system;
a first bypass valve in fluid communication with the bypass system and the engine cooling system, the first bypass valve adapted to be selectively moved between:
a bypass position that allows fluid communication between the bypass system and the engine cooling system; and
an engine system position that does not allow fluid communication between the engine cooling system and the bypass system; and
a second bypass valve in fluid communication with the bypass system and the secondary cooling system, the second bypass valve adapted to be selectively moved between:
a bypass position that allows fluid communication between the bypass system and the secondary cooling system; and
a secondary system position that does not allow fluid communication between the bypass system and the secondary cooling system.

5. The machine of claim 4 wherein the controller is further adapted to:
command the first bypass valve to move from the engine system position to the bypass position when the control valve is moved from the closed position to the open position; and
command the second bypass valve to move from the secondary system position to the bypass position when the control valve is moved from the closed position to the open position.

6. The machine of claim 2, further comprising:
a bypass system in fluid communication with the engine cooling system and the secondary cooling system;
a first bypass valve in fluid communication with the bypass system and the engine cooling system, the first bypass valve adapted to be selectively moved between:
a bypass position that allows fluid communication between the bypass system and the engine cooling system; and
an engine system position that does not allow fluid communication between the engine cooling system and the bypass system; and
a second bypass valve in fluid communication with the bypass system and the secondary cooling system, the second bypass valve adapted to be selectively moved between:
a bypass position that allows fluid communication between the bypass system and the secondary cooling system; and
a secondary system position that does not allow fluid communication between the bypass system and the secondary cooling system.
wherein the controller is further adapted to:
command the first bypass valve to move from the bypass position to the engine system position when the control valve is moved from the open position to the closed position; and
command the second bypass valve to move from the bypass position to the secondary system position when the control valve is moved from the open position to the closed position.

7. A machine comprising:
an engine;
an engine cooling system in operatively associated with the engine;
an engine system temperature sensor adapted to sense a temperature of the engine cooling system and provide a signal indicative of the temperature of the engine cooling system;
a secondary system with a low-temperature limit;
a secondary cooling system in operatively associated with the secondary system;
at least one secondary system temperature sensor adapted to sense a temperature of the secondary cooling system and provide a signal indicative of the temperature of the secondary cooling system;
a control valve including an open position that allows fluid communication between the engine cooling system and the secondary cooling system, and a closed position that disallows fluid communication between the engine cooling system and the secondary cooling system; and
a controller operatively associated with the control valve, the controller adapted to:
receive signals from the at least one secondary system temperature sensor indicative of the temperature of the secondary cooling system;
receive signals from the engine system temperature sensor indicative of the temperature of the engine cooling system; and
command the control valve to move to the open position when the temperature of the secondary cooling system is below the low-temperature limit and the temperature of the engine cooling system is above the low-temperature limit.

8. The machine of claim 7, further comprising:
a bypass system in fluid communication with the engine cooling system and the secondary cooling system;
a first bypass valve in fluid communication with the bypass system and the engine cooling system, the first bypass valve adapted to be selectively moved between:
a bypass position that allows fluid communication between the bypass system and the engine cooling system; and
an engine system position that does not allow fluid communication between the engine cooling system and the bypass system; and
a second bypass valve in fluid communication with the bypass system and the secondary cooling system, the second bypass valve adapted to be selectively moved between:
a bypass position that allows fluid communication between the bypass system and the secondary cooling system; and
a secondary system position that does not allow fluid communication between the bypass system and the secondary cooling system.

9. The machine of claim 8 wherein the controller is further adapted to:
command the first bypass valve to move from the engine system position to the bypass position when the control valve is moved from the closed position to the open position; and
command the second bypass valve to move from the secondary system position to the bypass position when the control valve is moved from the closed position to the open position.

10. The machine of claim 8 wherein the controller is further adapted to:
command the first bypass valve to move from the bypass position to the engine system position when the control valve is moved from the open position to the closed position; and
command the second bypass valve to move from the bypass position to the secondary system position when the control valve is moved from the open position to the closed position.

11. A method of integrating a cooling system, the method comprising steps of:
sensing a temperature of a secondary cooling system;
comparing the temperature of the secondary cooling system to a low-temperature limit of a secondary system; and
moving a control valve from a closed position that does not allow fluid communication between the secondary cooling system and an engine cooling system to an open position that allows fluid communication between the secondary cooling system and the engine cooling system if the temperature of the secondary cooling system is lower than the low-temperature limit.

12. The method of claim 11 wherein the secondary system is a hybrid electric system.

13. The method of claim 11, further comprising the step moving the control valve to the closed position to disallow fluid communication between the secondary cooling system and the engine cooling system at a time when the temperature of the secondary cooling system exceeds a predetermined temperature above the low-temperature limit.

14. The method of claim 11, further comprising the steps of:
sensing the temperature of the engine cooling system;
comparing the temperature of the engine cooling system to the low-temperature limit of the secondary cooling system; and
moving the control valve from the closed position to the open position if the temperature of the secondary cooling system is lower than the low-temperature limit and the temperature of the engine cooling system is higher than the low-temperature limit.

15. The method of claim 14 wherein the secondary system is a hybrid electric system.

16. The method of claim 14, further comprising the step of moving the control valve to the closed position at a time after the temperature of the secondary cooling system exceeds a predetermined temperature above the low-temperature limit.

17. The method of claim 11, further comprising steps of:
moving a first bypass valve from an engine system position to a bypass position to allow fluid communication between the engine cooling system and a bypass system when the control valve is moved from the closed position to the open position; and
moving a second bypass valve from a secondary system position to a bypass position to allow fluid communication between the secondary cooling system and the bypass system when the control valve is moved from the closed position to the open position.

18. The method of claim 17, further comprising the step of operatively associating the first bypass valve and the second bypass valve with a controller.

19. The method of claim 18, further comprising the steps of:
commanding the first bypass valve to move from the engine system position to the bypass position with the controller when the control valve is moved from the closed position to the open position; and
commanding the second bypass valve to move from the secondary system position to the bypass position with the controller when the control valve is moved from the closed position to the open position.

20. The method of claim 18, further comprising the steps of:
commanding the first bypass valve to move from the bypass position to the engine system position with the controller when the control valve is moved from the open position to the closed position; and
commanding the second bypass valve to move from the bypass position to the secondary system position with the controller when the control valve is moved from the open position to the closed position.
